(19) United States
(12) Patent Application Publication
(10) Pub. No.: US 2020/0346898 A1
(43) Pub. Date: Nov. 5, 2020

(54) ELEVATOR LANDING DOOR ASSEMBLY AND ITS INSTALLATION METHOD

(71) Applicant: Kone Corporation, Helsinki (FI)

(72) Inventors: Markku HAAPANIEMI, Helsinki (FI); Matti RASANEN, Helsinki (FI); Tarvo VIITA-AHO, Helsinki (FI); Anssi VENHO, Helsinki (FI)

(73) Assignee: Kone Corporation, Helsinki (FI)

(21) Appl. No.: 16/931,873

(22) Filed: Jul. 17, 2020

Related U.S. Application Data
(63) Continuation of application No. PCT/FI2018/050146, filed on Feb. 28, 2018.

(51) Int. Cl. B66B 13/30; B66B 19/00; E05D 15/06

(52) U.S. Cl. CPC B66B 13/30; B66B 19/00; E05D 15/0652; E05Y 2900/104; E05Y 2600/56; E05Y 2600/626; E05Y 2201/684

(57) ABSTRACT

The invention relates to an elevator landing door assembly and a method for installing an elevator landing door. The landing door assembly comprises at least a landing door unit to be assembled to a landing door base opening having an upper edge, two side edges and a lower edge, which landing door unit comprises at least a top track and one or more door panels suspended by the top track through one or more supporting elements, and a door sill. The assembly comprises fixing elements in the landing door base opening equipped with receiving parts for fastening the landing door unit.

### CROSS-REFERENCE TO RELATED APPLICATION

This application is a continuation of PCT International Application No. PCT/FI2018/050146 which has an International filing date of Feb. 2, 2018, the entire contents of which are incorporated herein by reference.

### BACKGROUND OF THE INVENTION

The present invention relates to an elevator landing door assembly as defined in the preamble of claim 1 and a method for installing an elevator landing door as defined in the preamble of claim 9.

In prior art solutions landing doors have been usually installed in connection with elevator installation. This has involved a lot of measuring, alignment work, boring and other manual work during the installation phase. This is very time consuming and also produces a lot of concrete dust to the elevator shaft and to all elevator spaces and components due to several boring tasks. The concrete dust may cause damages and is very difficult and slow to remove from all the contaminated places.

### SUMMARY

One object of the present invention is to eliminate the drawbacks of the solutions of prior art and to achieve an elevator landing door assembly, which is easy and fast to install and where the installing does not produce harmful concrete dust that contaminates surfaces and components in the installation location and its close neighborhood. Another object of the present invention is to achieve a method for installing an elevator landing door reliably, safely and fast and without causing a contaminating concrete dust. The elevator landing door assembly according to the invention is characterized by what is presented in the characterization part of claim 1. Correspondingly the method for installing an elevator landing door is characterized by what is presented in the characterization part of claim 9. Other embodiments of the invention are characterized by what is presented in the other claims.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise, the different details presented in connection with each embodiment can also be applied in other embodiments. In addition, it can be stated that at least some of the subordinate claims can, in at least some situations, be deemed to be inventive in their own right.

In order to achieve the objectives mentioned above, the present invention provides an elevator landing door assembly, which landing door assembly comprises at least a landing door unit to be assembled to a landing door base opening, which base opening has an upper edge, two side edges and a lower edge, which landing door unit comprises at least a top track and one or more door panels suspended by the top track through one or more supporting elements, and a door sill. Advantageously, the assembly comprises fixing elements in the landing door base opening equipped with receiving parts for fastening the landing door unit.

Preferably also, the present invention provides a method for installing an elevator landing door, which landing door assembly comprises at least a landing door unit to be assembled to a landing door base opening having an upper edge, two side edges and a lower edge, which landing door unit comprises at least a top track and one or more door panels suspended by the top track through one or more supporting elements, and a door sill. Advantageously, the landing door base opening is equipped with fixing elements comprising receiving parts for fastening the landing door unit, and the landing door unit is connected to the receiving parts from the side of the floor level and fastened to the receiving parts.

The solution according to the invention, comprising the elevator landing door assembly according to the invention and the method for installing the elevator landing door, has an advantage among other things that the solution saves a lot of installation work in the installation site because a prefabricated landing door unit with its possible frame is very fast and easy to install. Further one advantage is that the installation of the landing doors is easy and safe because almost all the work can be done on the landing floors. There is no need to go inside the elevator shaft, which would cause additional annoyance and danger. Yet another advantage is that the amount of concrete dust can be minimized because there is no need to make massive boring tasks. Also, the cleaning tasks after the installation are faster and easier because the amount of concrete dust is smaller.

### BRIEF DESCRIPTION OF THE DRAWINGS

In the following, the invention will be described in detail by the aid of embodiment examples by referring to the attached simplified and diagrammatic drawings, wherein

FIG. 1 presents in a simplified and diagrammatic oblique top view a landing door according to an advantageous embodiment of the invention in a floor of a building,

FIG. 2 presents in a simplified and diagrammatic top view an elevator landing door base opening with the visible walls cross-sectioned just above the floor level,

FIG. 3 presents in a simplified and diagrammatic oblique top view a lower fixing element of the landing door assembly according to the invention,

FIG. 4 presents in a simplified and diagrammatic oblique top view an upper fixing element of the landing door assembly according to the invention,

FIG. 5 presents in a simplified and diagrammatic view a landing door base opening equipped with the fixing elements according to the invention and seen from the elevator shaft,

FIG. 6 presents in a simplified and diagrammatic view the elevator landing door base opening according to FIG. 5 in a cross-section A-A,

FIG. 7 presents in a simplified and diagrammatic view the elevator landing door base opening according to FIG. 5 in a cross-section A-A, and in a situation where the fastening of a landing door unit has just been started,

FIG. 8 presents in a simplified and diagrammatic view the elevator landing door base opening according to FIG. 5 in a cross-section A-A, and in a situation where the landing door unit has been fastened at its place,

FIG. 9 presents in a simplified and diagrammatic view the elevator landing door base opening according to FIG. 5 seen from the elevator shaft, and in a situation where the landing door unit has been fastened at its place,

FIG. 10 presents in a simplified and diagrammatic view the elevator landing door base opening according to FIG. 5 in a cross-section A-A, and in a situation where the landing door unit has been fastened at its place totally inside the elevator shaft,

FIG. 11 presents in a simplified and diagrammatic front view a counter element to be fitted into the upper fixing element of the elevator landing door unit, and

FIG. 12 presents in a simplified and diagrammatic side view the counter element according to FIG. 11.

### DETAILED DESCRIPTION

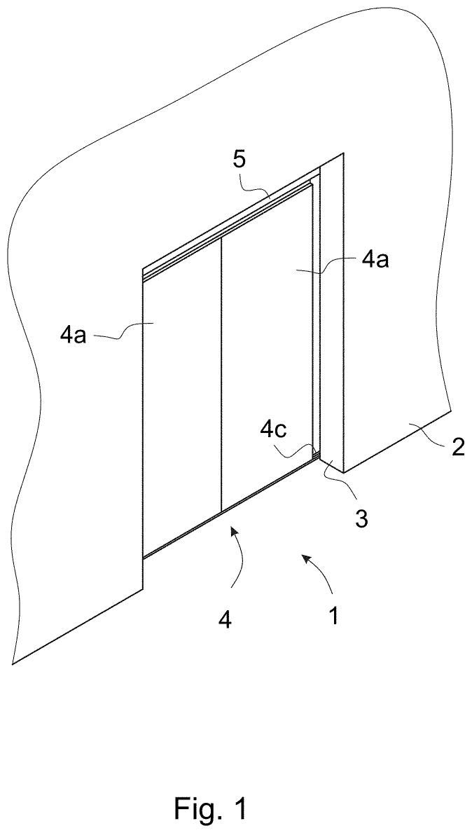

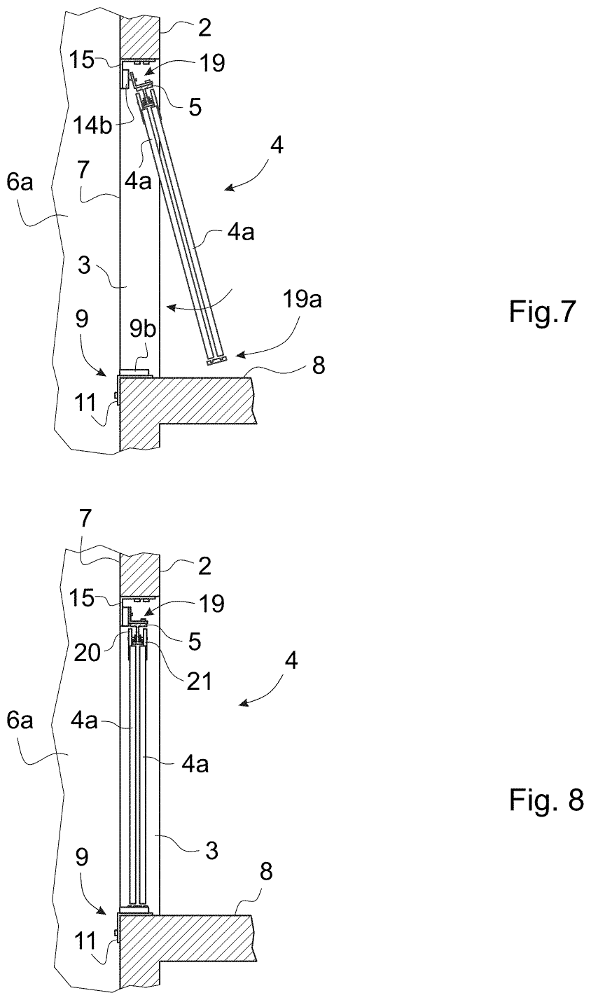

FIG. 1 presents in a simplified and diagrammatic oblique top view an installed elevator landing door assembly according to the invention. The landing door 1 with its top track 5, landing door unit 4 comprising advantageously a frame, two door panels 4a, and a door sill 4c has been installed into a base door opening 3 formed in a wall 2 of the building, which base door opening 3 opens to an elevator shaft. The base door opening 3 comprises an upper edge, two side edges and a lower edge. The type of the landing door in FIG. 1 is such that the door panels 4a open by separation from each other toward opposite directions and close toward each other by moving opposite directions. Thus, the landing door 1 opens from the middle. As well, the two-part landing door could open from one side as is presented later in FIGS. 7-10.

In FIG. 1 the landing door installation is not yet complete, so the top track 5 is seen above the door panels 4a, and also a part of the doorsill 4c is seen. The structure of the landing door 1 does not necessarily cover the whole base door opening 3, but the final covering is implemented with covering plates or corresponding structures that are fitted to close all the gaps between edges of the base door opening 3 and the door panels 4a and other door components at both the sides of the base door opening 3 and above it.

Advantageously the base door opening 3 and its gaps can be covered, for example during the installation time, with a protection wall, such as a hard gypsum panel. This is done preferably to protect against safety hazards until the door or complete elevator installation is to be finalized. Preferably the hard gypsum panel can be enforced.

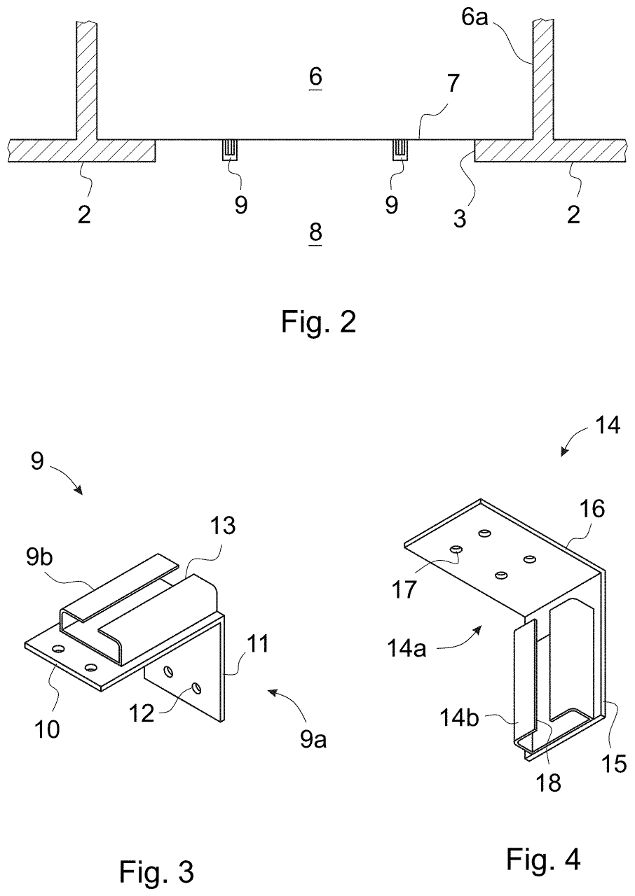

FIG. 2 presents in a simplified and diagrammatic top view an elevator landing door base opening 3 with the visible walls cross-sectioned just above the floor level 8. Only a part of elevator shaft 6 and its sidewalls 6a is seen in FIG. 2 but the front wall 7 of the elevator shaft is completely seen.

A pair of lower fixing elements 9 for the elevator landing door unit 4 is fastened onto the floor 8 at the base door opening 3. In this embodiment the lower fixing elements 9 extent downwards in the vertical level of the front wall 7 of the elevator shaft 6.

FIG. 3 presents in a simplified and diagrammatic oblique top view the lower fixing element 9 of the landing door assembly according to the invention. The lower fixing element 9 comprises a frame 9a and a receiving part 9b for receiving counter parts of the lower part of the landing door unit 4 to be installed to the base opening 3. The frame 9a is advantageously an L-shape element with a first flange 10 and a second flange 11 that are substantially perpendicular to each other. In addition the frame 9a comprises fastening holes 12 through which the lower fixing element 9 is fastened at its place onto the edge of the floor 8 at the base door opening 3. The fastening can be made with fastening elements such as screws either onto the floor 8 or onto the front wall 7 of the elevator shaft 6, or onto the both.

The first flange 10 is advantageously a horizontal flange and is equipped with the receiving part 9b whose cross-section is like a C-profile, which has a hollow interior, and where a longitudinal slot 13 is upward. When the lower fixing element 9 is fastened to its place the longitudinal slot 13 is directed horizontally towards the elevator shaft 6, and is perpendicular to the width of the base opening 3.

FIG. 4 presents in a simplified and diagrammatic oblique top view an upper fixing element 14 of the landing door assembly according to the invention. The upper fixing element 14 comprises a frame 14a and a receiving part 14b for receiving counter parts of the upper edge of the landing door unit 4 to be installed to the base opening 3. The frame 14a is advantageously an L-shape element with a first flange 15 and a second flange 16 that are substantially perpendicular to each other. In addition the frame 14a comprises fastening holes 17 through which the upper fixing element 14 is fastened at its place onto the upper edge of the base door opening 3. The fastening can be made with fastening elements such as screws onto the upper edge of the base door opening 3.

The first flange 15 of the upper fixing element 14 is advantageously a vertical flange and is equipped with the receiving part 14b whose cross-section is like a C-profile which has a hollow interior, and where the longitudinal slot 18 is vertical. When the upper fixing element 14 is fastened to its place the longitudinal slot 18 is vertical and opens perpendicularly away from the elevator shaft 6 towards the lobby of the floor level.

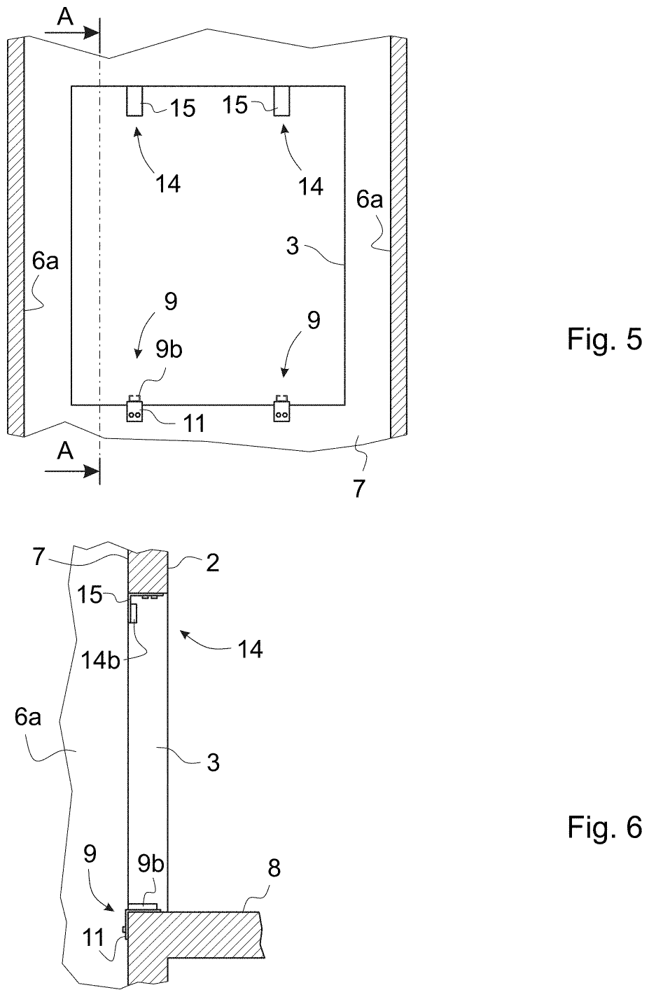

FIGS. 5 and 6 present in a simplified and diagrammatic view the landing door base opening 3 equipped with the fixing elements 9 and 14 according to the invention. In FIG. 5 the landing door base opening 3 is seen from the elevator shaft 6, and in FIG. 6 the landing door base opening 3 is seen in a cross-section A-A of FIG. 5.

The lower fixing elements 9 are fastened into their place on the edge of the floor of the floor level 8 so that the first flange 10 lies on the floor 8 and the second flange 11 is fastened with fastening elements to the vertical front wall 7 of the elevator shaft. Advantageously the fastening elements are fastening screws or bolts. After fastening the receiving part 9b is preferably inside the thickness of the wall 2 in a horizontal position and the longitudinal slot 13 is directed horizontally towards the elevator shaft 6, and is perpendicular to the width of the door base opening 3, as is described above. Advantageously the landing door assembly according to the invention comprises two similar lower fixing elements 9 that are situated horizontally apart from each other and each in its own vertical line with the other corresponding lower fixing elements 9 of the other floors of the building.

The upper fixing elements 14 are fastened into their place on the upper edge of the door base opening 3 so that the first flange 15 extends downwards and the second flange 16 is fastened with fastening elements to the horizontal upper edge of the door base opening 3, preferably inside the thickness of the wall 2. Advantageously the fastening elements are fastening screws or bolts. After fastening the receiving part 14b is preferably inside the thickness of the wall 2 in a vertical position and the longitudinal slot 18 is open away from the elevator shaft 6 towards the lobby of floor level 8, as is described above. Advantageously the landing door assembly according to the invention comprises two similar upper fixing elements 14 that are situated horizontally apart from each other and each in its own vertical line with the other corresponding upper fixing elements 14 of the other floors of the building.

FIGS. 7-9 present in a simplified and diagrammatic view the installation of the elevator landing door unit 4 into the elevator landing door base opening 3. Advantageously the elevator landing door unit 4 also comprises a frame that is not presented in the figures.

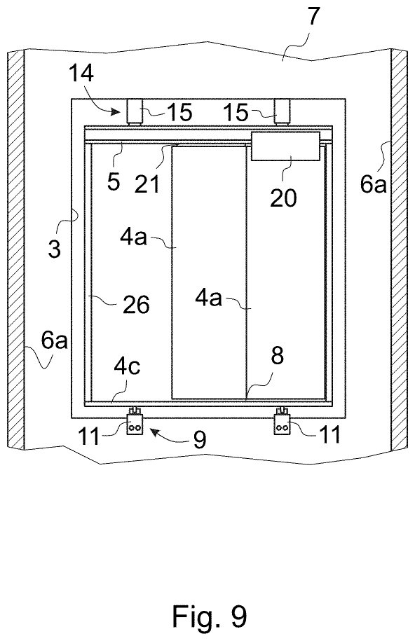

FIGS. 7 and 8 are shown in the cross-section A-A of FIG. 5, and FIG. 9 is seen from the elevator shaft 6. In FIG. 7 the fastening of the landing door unit 4 has been just started, and in FIGS. 8 and 9 the landing door unit 4 has been fastened at its place inside the landing door base opening 3 within the thickness of the wall 2. FIGS. 7-9 show such an embodiment of the invention where the landing door opens to one side. In this embodiment the door panels 4a are suspended from the top track 5 in different sides of the top track 5 so that the first door panel 4a is suspended by a first supporter 20 in the first side of the top track 5 and the second door panel 4a is suspended by a second supporter 21 in the second side of the top track 5.

The landing door unit 4 comprises upper counter parts 19 at its upper edge and lower counter parts 19a at its lower edge. The number of upper and lower counterparts 19, 19a is the same as the number of upper and lower fixing elements 9, 14 in one elevator landing door base opening 3. Advantageously the landing door unit 4 comprises two upper counter parts 19 and two lower counter parts 19a. The horizontal distance between the upper counter parts 19 is the same as the horizontal distance between the upper fixing elements 14, and the horizontal distance between the lower counter parts 19a is the same as the horizontal distance between the lower fixing elements 9.

The landing door unit 4 that is prefabricated in a factory, is installed to the base door base opening 3 by guiding the upper counter parts 19 first from under to the vertical slots 18 of the upper fixing elements 14. When the upper counter parts 19 are guided by the vertical slots 18 the landing door unit 4 is pushed upward and preferably simultaneously its lower edge is turned towards the elevator shaft 6. The turning is continued until the lower counter parts 19a reach the lower fixing elements 9. At this time the lower counter parts 19a are guided to the horizontal slots 13 of the lower fixing elements 9 and the turning is continued until the landing door unit 4 is substantially in a vertical position in its place. After that the final position of the landing door unit 4 is adjusted in the fixing elements 9 and 14.

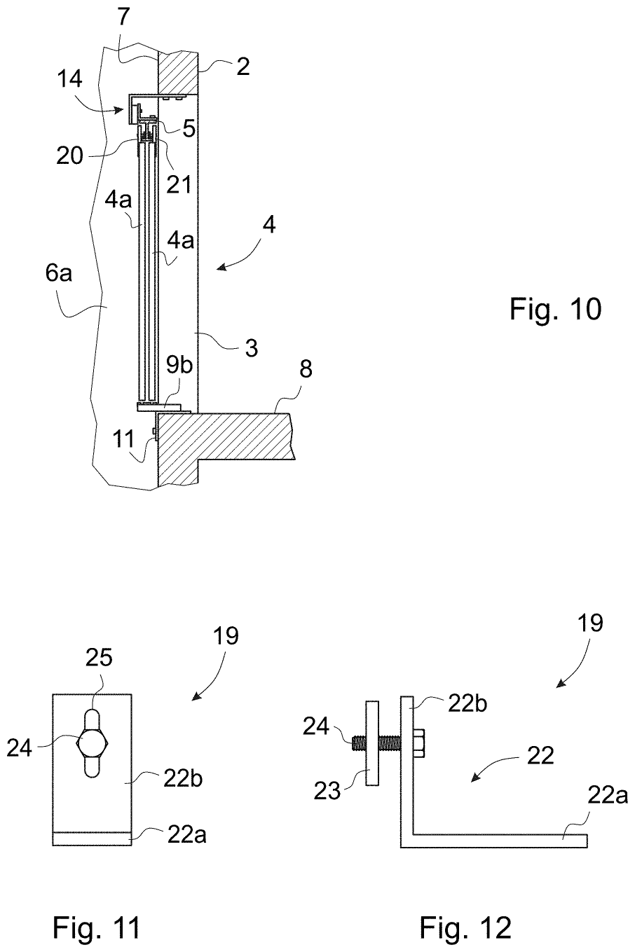

FIG. 10 presents in a simplified and diagrammatic view the elevator landing door base opening 3 according to FIG. 5 in the cross-section A-A, and in a situation where the landing door unit 4 has been fastened at its place. In this embodiment the landing door unit 4 is fastened totally inside the elevator shaft 6 and for that reason the fixing elements 9 and 14 differ in their structures from the fixing elements 9 and 14 presented in FIGS. 2-9. The only decisive difference is that the receiving part 9b of the lower fixing elements 9 extends inside the elevator shaft 6 and the receiving part 14b of the upper fixing elements 14 is totally inside the elevator shaft 6. The landing door unit 4 itself can be similar to the landing door unit 4 presented in FIGS. 7-9.

FIGS. 11 and 12 present an upper counter element 19 to be fitted into the upper fixing element 14 of the elevator landing door unit 4. The upper counter element 19 comprises an L-shaped frame 22 with a first flange 22a and a second flange 22b which flanges are perpendicular to each other. The upper counter element 19 is fastened to the upper edge of the landing door unit 4 through the first flange 22a with fastening elements, such as screws. The second flange 22b is preferably in a vertical position and comprises a longitudinal vertical slot 25 for adjusting the height position of the landing door unit 4. The slot 25 is equipped with a bolt 24 that is fastened with screw threads to a tightening element 23, such as a tightening plate.

The width of the tightening element 23 is smaller than the width of interior of the C-profile of the receiving part 14b, and the diameter of the bolt 24 is smaller than the width of the slot 18 of the receiving part 14b. Therefore, when installing the landing door unit 4 the tightening element 23 can be placed inside the C-profile of the receiving part 14b in such a way that the bolt 24 is guided by the slot 18. When the landing door unit 4 is adjusted to its correct height position the tightening element 23 is tightened by the help of the bolt 24 to the receiving part 14b so that the landing door unit 4 remains its correct height position. The structure of the lower counter parts 19a can be substantially the same as the structure of the upper counter parts 19 but may also be different.

The combination of lower fixing elements 9 with the lower counter parts 19a and the upper fixing elements 14 with the upper counter parts 19 makes it possible to adjust the position of the landing door unit 4 in three dimensions. This is useful when performing the final position adjustments of the landing doors.

With the installation method according to the invention the landing door assembly can be safely installed from the landing side. This means that all the installation work can be done from the side of the floor level 8 and there is no need to go to the elevator shaft 6.

The installation method according to the invention has advantageously at least steps as follows:
the lower fixing elements 9 and the upper fixing elements 14 are fastened into their places in the landing door base opening 3
the prefabricated landing door unit 4 with its frame is suspended first to the upper fixing elements 14 by guiding the upper counter parts 19 to the receiving parts 14b of the upper fixing elements 14
the lower part of the landing door unit 4 is turned towards the elevator shaft 6 and the lower counter parts 19a are secured to the lower fixing elements 9
the landing door base opening 3 or at least gaps at the opening are covered with a hard protection wall or plate.

It is obvious to the person skilled in the art that the invention is not restricted to the example described above but that it may be varied within the scope of the claims presented below.

1. Elevator landing door assembly, which landing door assembly comprises at least a landing door unit to be assembled to a landing door base opening having an upper edge, two side edges and a lower edge, which landing door unit comprises at least a top track and one or more door panels suspended by the top track through one or more supporting elements, and a door sill, wherein the assembly comprises fixing elements in the landing door base opening equipped with receiving parts for fastening the landing door unit.

2. Elevator landing door assembly according to claim 1, wherein the assembly comprises at least two lower fixing elements fastened into the lower edge of the landing door base opening and at least two upper fixing elements fastened into the upper edge of the landing door base opening.

3. Elevator landing door assembly according to claim 2, wherein the landing door unit comprises upper counter parts to be fastened to the upper fixing elements, and lower counter parts to be fastened to the lower fixing elements.

4. Elevator landing door assembly according to claim 1, wherein the receiving part of the upper fixing element comprises a hollow interior and a vertical slot to receive the upper counterpart of the landing door unit.

5. Elevator landing door assembly according to claim 1, wherein the receiving part of lower fixing element comprises a hollow interior and a horizontal slot to receive the lower counterpart of the landing door unit.

6. Elevator landing door assembly according to claim 1, wherein the upper counterpart comprises an adjustment mechanism for the height adjustment of the landing door unit.

7. Elevator landing door assembly according to claim 1, wherein the lower fixing elements and the upper fixing elements of different floors are aligned in two vertical lines.

8. Elevator landing door assembly according to claim 1, wherein the installed landing door in the landing door base opening comprises a protective cover, such as a hard gypsum board.

9. Method for installing an elevator landing door, which landing door assembly comprises at least a landing door unit to be assembled to a landing door base opening having an upper edge, two side edges and a lower edge, which landing door unit comprises at least a top track and one or more door panels suspended by the top track through one or more supporting elements, and a door sill, wherein the landing door base opening is equipped with fixing elements comprising receiving parts for fastening the landing door unit, and the landing door unit is connected to the receiving parts from the landing side and fastened to the receiving parts.

10. Method for installing an elevator landing door according to claim 9, wherein at first the upper edge of the landing door unit is connected to the receiving parts of the upper fixing elements and after that the lower part of the landing door unit is turned towards the elevator shaft and towards the lower fixing elements and connected to the receiving parts of the lower fixing elements.

11. Method for installing an elevator landing door according to claim 9, wherein when connecting to the receiving parts of the upper fixing elements the adjustment mechanisms of the upper counter parts are inserted to the hollow interiors and to the slots of the receiving parts.

12. Method for installing an elevator landing door according to claim 11, wherein after the insertion of the adjustment mechanism of the upper counterpart to the hollow interior and to the slot of the receiving part the landing door unit is pushed upwards and the lower part of the landing door unit is turned towards the elevator shaft and towards the lower fixing element to connect and fasten the lower counterpart to the receiving part of the lower fixing element.

13. Method for installing an elevator landing door according to claim 9, wherein after the counter parts of the landing door unit are connected to the fixing elements the height of the landing door unit is adjusted and the landing door unit is secured into its final location.

14. Method for installing an elevator landing door according to claim 9, wherein after the fastening of the landing door unit the landing door base opening is covered by a protective wall.
